(19) United States
(12) Patent Application Publication
(10) Pub. No.: US 2021/0108024 A1
(43) Pub. Date: Apr. 15, 2021

(54) USE OF EPOXIDIZED SOY FATTY ACID ESTERS AS REACTIVE DILUENTS AND MODIFIERS IN EPOXY COATINGS AND RESINS

(71) Applicant: Archer Daniels Midland Company, Decatur, IL (US)

(72) Inventors: Erik Hagberg, Decatur, IL (US); Stehpen J. Howard, Sherman, IL (US); Teodora R. Tabuena-Salyers, Decatur, IL (US)

(73) Assignee: Archer Daniels Midland Company, Decatur, IL (US)

(21) Appl. No.: 16/603,053

(22) PCT Filed: Mar. 6, 2018
(86) PCT No.: PCT/US18/21023

§ 371 Date: Oct. 4, 2019

Related U.S. Application Data
(60) Provisional application No. 62/481,794, filed on Apr. 5, 2017.

(51) Int. Cl. C08G 59/36; C08G 59/22

(52) U.S. Cl. CPC C08G 59/36; C08G 59/223

(57) ABSTRACT

An epoxy resin composition is provided which comprises an epoxy resin and a reactive diluent comprising one or more of the monoesters of epoxidized soy oil characterized by a ratio of mols of epoxide groups to mols of ester on the whole of at least 1.35:1. A thermoset plastic composition is also provided which comprises an epoxy resin composition as described, with an amine curing agent.

### TECHNICAL FIELD

This invention relates generally to reactive diluents and modifiers in epoxy coatings and resins.

### BACKGROUND ART

Epoxy resins have found a wide range of applications and a steady rate of growth over the years in large measure due to their versatility. Properties of the cured products can be tailored by judicious selection of resin, modifier, cross-linking agent and the curing schedule.

The main attributes of properly cured epoxy systems are outstanding adhesion to a wide variety of substrates, including metals and concrete; an ability to cure over a wide range of temperatures; very low shrinkage on cure; excellent resistance to chemicals and corrosion; excellent electrical insulation properties; and high tensile, compressive and flexural strengths. These attributes suit epoxy resins extremely well for protective coating systems, but epoxies do also tend to exhibit a degree of inherent brittleness and poor crack resistance, which tends to limit their use in some structural applications.

Commonly, reactive diluents and modifiers have been used in epoxy resin compositions to modify the viscosity of the uncured resin, extend potlife and improve the toughness or other properties of cured epoxy resins, as well as to reduce costs. Reactive diluents often also permit higher loading, better wetting and bonding of pigments and of fillers during impregnation of composite resins with the fillers. Common reactive diluents for epoxy resins include butyl glycidyl ether, (C₁₂-C₁₄) glycidyl ethers (AGE), cresyl glycidyl ether and 2-ethylhexyl glycidyl ether. The glycidyl ethers provide a fast ambient temperature cure with amine-based curing agents such as, for example, triethylenetetramine (TETA). There are, however, growing toxicological and environmental concerns surrounding these known reactive diluents.

As a consequence, in recent years efforts have been made and reported to develop alternative, renewable source-based materials which could serve as effective reactive diluents and modifiers in epoxy resin systems. Plant oils are a rich source of polymer precursors, are abundant and inexpensive, and by virtue of their triglyceride chains having varying lengths and degrees of unsaturation lend themselves to a variety of chemical modifications.

Among all of the plant oils, soybean oil has attracted particular attention, however, epoxidized soybean oil has been found largely unsuitable as an alternative due to excess plasticization caused by its long aliphatic chains, low crosslink density and low reactivity. A heterogeneous structure is reported to result during the curing reaction that leads to phase separated materials and poor mechanical properties.

A limited amount of further work is reported on esters of epoxidized soybean oil (ESO) as potential renewable source-based replacement reactive diluents and modifiers. An article published in 2004, Zhu et al., “Curing and Mechanical Characterization of a Soy-Based Epoxy Resin System”, Journal of Applied Polymer Science, Vol. 91, pp. 3513-3518, describes studies of epoxidized methyl and allyl soyate esters—mixtures of epoxidized esters of the linoleic, oleic, palmitic, linolenic and stearic acids—as reactive diluents, and concludes as to EMS that “no apparent improvement has been observed over ESO”, the lack of improvement being attributed in part to the “very low degree of epoxidation” and to the non-reactive (for cross-linking purposes) palmitic and stearic methyl esters.

However, more recently, in Sahoo et al., “Toughened Bio-based Epoxy Blend Network Modified with Transesterified Epoxidized Soybean Oil: Synthesis and Characterization”, RSC Advances, no. 5, pp. 13674-13691 (2015) (hereafter, “Sahoo et al.”), further investigations are reported of epoxidized methyl soyate esters (EMS) as a reactive diluent, wherein EMS prepared from ESO by base-catalyzed transesterification (which Sahoo et al. distinguished as “relatively different” from the methods used in other, prior studies such as the 2004 study) was compared for effectiveness against the conventional material, AGE, that EMS would displace. While Sahoo et al. found that adding 20 weight percent or preferably 30 percent of EMS to an epoxy prior to curing enabled enhanced impact strength and fracture toughness, providing an “appropriate balance of stiffness and toughness” (p. 13683), nevertheless reduced flexural strength was noted consistent with the prior 2004 study, again being attributed in part to the “comparatively low oxirane content (6.2%) value after transesterification and the presence of non-reactive palmitic and stearic structures, which are devoid of the oxirane ring.” (p. 13682) Increased brittleness was also attributed to the use of EMS as a reactive diluent, specifically by reason of the unreactive palmitic and stearic methyl esters remaining unreacted in the cured sample tested (p. 13683).

### SUMMARY OF THE INVENTION

The following presents a simplified summary of the invention in order to provide a basic understanding of some of its aspects. This summary is not an extensive overview of the invention and is intended neither to identify key or critical elements of the invention nor to delineate its scope. The sole purpose of this summary is to present some concepts of the invention in a simplified form as a prelude to the more detailed description that is presented later.

The present invention from one perspective relates to the discovery that, quite contrary to what one of skill in the art would have expected in light of the 2015 and earlier studies, reactive diluents comprised of one or more of the monoesters of epoxidized soy oil can provide a toughening of a cured epoxy resin composition of which they form a part while also providing equivalent or improved flexural strength or hardness performance as compared to the known reactive diluents with their attendant toxicological and environmental concerns, provided the one or more monoesters are characterized by a ratio of mols of epoxide groups to mols of ester on the whole of at least 1.35:1 (we have calculated based on the compositional information given in Sahoo et al as to their soy oil (51% linoleic acid, 25% oleic acid, 10% palmitic acid, 7% linolenic acid, 5% stearic acid) that Sahoo et al's EMS was characterized by a ratio of 1.21:1, and based on an assumed average soy oil profile for the 2004 Zhu et al. work that the EMS used therein was characterized by a ratio of 1.28:1).

We have further unexpectedly found that despite the presence of the sane palmitic and stearic methyl esters in our reactive diluents, increased brittleness is also not observed, and in fact less brittle materials are enabled.

Still further, while the most recent 2015 journal article attributed a sacrifice in flexural strength at least in part to the “comparatively low oxirane content value after transesterification”, we have found improvements in toughness may surprisingly be realized while maintaining flexural strength in cured epoxy compositions, with the use of monoesters of epoxidized soy oil with oxirane values even lower than the reported 6.2 percent for the EMS used in the 2015 study.

Accordingly, in one aspect, the present invention is directed to an epoxy resin composition is provided which comprises an epoxy resin and a reactive diluent comprising one or more of the monoesters of epoxidized soy oil characterized by a ratio of mols of epoxide groups to mols of ester on the whole of at least 1.35:1.

In another embodiment, the one or more monoesters of epoxidized soy oil are characterized by a ratio of mols of epoxide groups to mols of ester on the whole of at least 1.37:1.

In another embodiment, the one or more monoesters of epoxidized soy oil are characterized by a ratio of mols of epoxide groups to mols of ester on the whole of at least 1.39:1.

In certain embodiments, the one or more monoesters of epoxidized soy oil so characterized include at least one monoester of epoxidized soy oil having an oxirane content of less than 6.2%.

In another embodiment, the reactive diluent comprises one or more monoesters of epoxidized soy oil selected from the group consisting of the methyl, ethyl, propyl, butyl, amyl, 2-ethylhexyl, benzyl, 5-(hydroxymethyl)furfuryl, 2,5-bis(hydroxymethyl)tetrahydrofurfuryl monoesters of epoxidized soy oil and mixtures thereof.

In another embodiment, the reactive diluent is a mixture of epoxidized soyate esters as may be made by the interesterification of epoxidized soybean oil with ethyl acetate.

In another aspect, the present invention is directed to a thermoset plastic composition comprising an epoxy resin composition as described herein and an amine.

### DETAILED DESCRIPTION OF EMBODIMENTS

As used in this application, the singular forms “a”, “an” and “the” include plural references unless the context clearly indicates otherwise. The term “comprising” and its derivatives, as used herein, are similarly intended to be open ended terms that specify the presence of the stated features, elements, components, groups, integers, and/or steps, but do not exclude the presence of other unstated features, elements, components, groups, integers and/ or steps. This understanding also applies to words having similar meanings, such as the terms “including”, “having” and their derivatives. The term “consisting” and its derivatives, as used herein, are intended to be closed terms that specify the presence of the stated features, elements, components, groups, integers, and/or steps, but exclude the presence of other unstated features, elements, components, groups, integers, and/or steps. The term “consisting essentially of”, as used herein, is intended to specify the presence of the stated features, elements, components, groups, integers, and/ or steps, as well as those that do not materially affect the basic and novel characteristic(s) of stated features, elements, components, groups, integers, and/or steps.

Unless otherwise indicated, any definitions or embodiments described in this or in other sections are intended to be applicable to all embodiments and aspects of the subjects herein described for which they would be suitable according to the understanding of a person of ordinary skill in the art.

As indicated above, the present invention in one aspect relates to an epoxy resin composition which comprises a) an epoxy resin and b) a reactive diluent comprising one or more of the monoesters of epoxidized soy oil characterized by a ratio of mols of epoxide groups to mols of ester on the whole of at least 1.35:1. In this regard, a “monoester of epoxidized soy oil” as used herein and throughout will be understood as not limited to being made by the transesterification of ESO but as also encompassing a method of making whereby the fatty acid esters of soy oil are made and then epoxidized.

The epoxy resin can be any epoxy resin, including both glycidyl and non-glycidyl epoxides. Preferred monoesters of epoxidized soy oil are selected from the group consisting of the methyl, ethyl, propyl, butyl, amyl, 2-ethylhexyl, benzyl, 5-(hydroxymethyl)furfuryl, 2,5-bis(hydroxymethyl)tetrahydrofurfuryl monoesters of epoxidized soy oil and mixtures thereof. Preferred epoxy resin compositions of the present invention include a monoester selected from this group and which is characterized by a ratio of mols of epoxide groups to mols of ester on the whole of at least 1.35:1. Where a combination of monoesters of epoxidized soy oil from the preferred monoesters is to be employed, the combination will be characterized across the combination by a ratio of mols of epoxide groups to mols of ester on the whole of at least 1.35:1.

We have found as previously noted that reactive diluents comprised of one or more of the monoesters of epoxidized soy oil can provide a toughening of a cured epoxy resin composition of which they form a part while also maintaining its flexural strength or hardness, provided the one or more monoesters are characterized by a ratio of mols of epoxide groups to mols of ester on the whole of at least 1.35:1, though in preferred embodiments, the characteristic ratio will be at least 1.37:1, and in more preferred embodiments, the characteristic ratio will be at least 1.39:1.

A commercially available, epoxidized methyl soyate ester product providing the more preferred ratio is shown in the examples which follow, and is produced and sold as ADM CA 118 by Archer Daniels Midland Company, Decatur, Ill. for use as a low VOC coalescing solvent in paints and coating formulations. Exemplary, but non-limiting, methods of making epoxidized methyl soyate monoesters are described in Archer Daniels Midland Company's U.S. Pat. No. 9,000,196 and WO 2013/ 002913. This material is characterized by an oxirane value of 7%, a mols of epoxide groups to mols of ester ratio of 1.39:1 and an epoxy equivalent weight (EEW) of from 209 to 217.

Monoesters of epoxidized soy oil having a lower oxirane value than either the epoxidized methyl soyate esters used in Zhu et al. (estimated as 6.46 using their reported “85% epoxidized” material and an average commercial soy fatty acid profile) or Sahoo et al's self-reported 6.2% oxirane value EMS are also contemplated as useful in the present invention, and surprisingly enable improvements in toughness while maintaining flexural strength in cured epoxy compositions where the selected monoesters are characterized by a ratio of mols of epoxide groups to mols of ester on the whole of at least 1.35:1. The epoxidized benzyl soyate esters made according to Archer Daniels Midland Company's U.S. Pat. No. 8,703,849 to Hagberg et al. are exemplary of such useful materials, and are characterized by an oxirane value of 6.1% and an epoxy equivalent weight of 217, but a ratio of mols epoxide groups to mols of ester of 1.49.

In one application of the epoxy resin compositions of the present invention, a thermoset plastic composition is constituted which comprises an epoxy resin composition as described and claimed herein and an amine as a hardener or curing agent. Examples of preferred amines include (list). In other embodiments of thermoset plastic compositions made using the biobased reactive diluents and resultant epoxy resin compositions incorporating the same biobased reactive diluents, other conventional hardeners or curing agents may be used. Other conventional components of the epoxy thermoset art may be incorporated as well, including, for example, pigments and fillers, as known in the art.

Because of the combination of toughness, flexural strength and improvements in brittleness or impact resistance enabled by the biobased reactive diluents of the present invention in the epoxy resin compositions of the present invention when included in a thermoset plastic composition and cured in keeping with conventional practice in the epoxy thermoset art, a variety of applications and end uses are foreseen, including, without limitation, the wood floor coating and concrete floor sealer applications addressed in the examples below.

The present invention is further demonstrated by the non-limiting examples that follow:

### EXAMPLES 1-4

Archer Daniels Midland Company's ADM CA 118 epoxidized methyl soyate ester (EMS) and epoxidized benzyl soyate ester products, as well as various known reactive diluents, were blended with an undiluted clear difunctional bisphenol A/epichlorohydrin derived epoxy resin (EPON™ 828 resin, Hexion Inc.) to evaluate the comparative effectiveness of these epoxidized methyl and benzyl soyate ester materials for reducing the viscosity of the uncured epoxy resin at various weight percentages in the resin, using a Brookfield CAP 2000+ viscometer at 15 rpm with a #1 spindle. These comparisons were undertaken on two different occasions and with two different lots of the epoxy resin, with certain commercial diluents being tested on one occasion alongside the Archer Daniels Midland Company products and more being tested on a second occasion opposite ADM's EMS product.

Subsequently, on each of the two occasions, these various epoxy resin compositions were combined with a low viscosity reactive polyamide curing agent (EPIKURE™ 3140 curing agent, Hexion Inc.) in the same stoichiometric ratio, and viscosity measurements were taken at 15 minutes from the combining and thereafter at one hour intervals using the same Brookfield CAP 2000+ viscometer at 15 rpm with a #1 spindle, until the resultant thermoset composition had crosslinked to an extent that the viscosity could no longer be measured. The time in hours corresponding to this circumstance was then recorded, for comparing the effectiveness of the ADM products against known commercial reactive diluents in extending potlife.

The results of viscosity measurements on the uncured epoxy resin compositions are found in Tables 1 and 2, where the viscosities are reported in poise, while the results of the potlife measurements with the thermoset compositions are found in Tables 3 and 4:

TABLE 1
Viscosity Reduction in Uncured Resin -1^{st} Set

| Diluent | 0% | 5% | 10% | 15% | 20% | 25% |
|---|---|---|---|---|---|---|
| CA 118 | 75.37 | 49.75 | 28.5 | 18.25 | 12.37 | 9.875 |
| Epodil ® 741^{(a)} | 75.37 | 29.25 | 11.62 | 5.875 | 3.875 | 2.75 |
| Epodil ® 746^{(b)} | 75.37 | 38.75 | 18.75 | 10.62 | 6.75 | 5.125 |
| Heloxy ™ Mod. 8^{(c)} | 75.37 | 41.87 | 20.87 | 13 | 8.75 | 6.25 |
| Cardura ™ E10P^{(d)} | 75.37 | 51 | 31 | 19.25 | 13.37 | 9.75 |
| Heloxy ™ Mod. | 75.37 | 62.5 | 50.75 | 42.75 | 36.25 | 30.75 |
| 505^{(e)} | | | | | | |

^{(a)}N-butyl glycidyl ether, Air Products and Chemicals, EEW 145-155
^{(b)}2-ethylhexyl glycidyl ether, Air Products and Chemicals, EEW 215-230
^{(c)}C₁₂-C₁₄ aliphatic monoglycidyl ether, Hexion Inc., EEW 280-295
^{(d)}glycidyl ester of a highly branched saturated monocarboxylic acid of ten carbon atoms, Hexion Inc., EEW 235-244
^{(e)}castor oil polyglycidyl ether, Hexion Inc., EEW 500-650

TABLE 2
Viscosity Reduction in Uncured Resin - 2^{nd} Set

| Diluent | 0% | 5% | 10% | 15% | 20% | 25% |
|---|---|---|---|---|---|---|
| CA 118 | 82.5 | 53.28 | 30.25 | 19.37 | 13.25 | 10.62 |
| Epodil ® 749^{(a)} | 82.5 | 61.62 | 36.12 | 26.5 | 20.25 | 13 |
| Epodil ® 7500^{(b)} | 82.5 | 49.25 | 27.5 | 18.37 | 11.37 | 9 |
| Epodil ® 757^{(c)} | 82.5 | 70 | 46.87 | 36.12 | 26.37 | 20 |
| Epodil ® 759^{(d)} | 82.5 | 42.25 | 20.87 | 11.75 | 7.625 | 5.125 |
| EBS | 82.5 | 59 | 37.75 | 25.37 | 18.12 | 13.62 |

^{(a)}neopentyl glycol diglycidyl ether, EEW 130-145, Air Products
^{(b)}1,4-butanediol diglycidyl ether, EEW 122-135, Air Products
^{(c)}cyclohexane dimethylol diglycidyl ether, EEW 145-168, Air Products
^{(d)}alkyl (C12-C13) glycidyl ether, EEW 275-290, Air Products

TABLE 3
Potlife in Hours - 1^{st} Set

| Diluent | 0% | 5% | 10% | 15% | 20% | 25% |
|---|---|---|---|---|---|---|
| CA 118 | 2 | 2 | 3 | 4 | 5 | 5 |
| Epodil ® 741 | 2 | 3 | 3 | 5 | 6 | 6 |
| Epodil ® 746 | 2 | 3 | 3 | 4 | 5 | 6 |
| Heloxy ™ Mod. 8 | 2 | 2 | 3 | 4 | 5 | 6 |
| Cardura ™ E10P | 2 | 2 | 3 | 4 | 4 | 5 |
| Heloxy ™ Mod. 505 | 2 | 2 | 2 | 2 | 2 | 2 |

TABLE 4
Potlife in Hours - 2^{nd} Set

| Diluent | 0% | 5% | 10% | 15% | 20% | 25% |
|---|---|---|---|---|---|---|
| CA 118 | 1 | 2 | 2 | 2 | 4 | 4 |
| Epodil ® 749 | 1 | 1 | 1 | 2 | 3 | 3 |
| Epodil ® 750 | 1 | 2 | 2 | 2 | 2 | 3 |
| Epodil ® 757 | 1 | 1 | 1 | 2 | 2 | 2 |
| Epodil ® 759 | 1 | 2 | 2 | 3 | 4 | 4 |
| EBS | 1 | 1 | 2 | 2 | 3 | 4 |

### EXAMPLE 5

A quantity of the undiluted clear difunctional bisphenol A/epichlorohydrin derived epoxy resin (EPON™ 828 resin, Hexion Inc.) was first diluted with 10% by weight of xylene, thus providing a reduced viscosity mixture of 10% of xylene and 90% of the epoxy resin, before the addition of various amounts of the conventional and inventive diluents shown in Table 5 below. Percentage loadings of the diluents are on the basis of the total weight of the diluent, epoxy resin and xylene in combination. These epoxy resin compositions were then combined with the same low viscosity reactive polyamide curing agent (EPIKURE™ 3140 curing agent, Hexion Inc.) as used in Examples 1-4, in each case at the same stoichiometric ratio, and the resultant thermoset compositions were left standing for fifteen minutes. The various thermoset compositions were then applied on Q-panel coating test substrates at 6 mils wet thickness. After drying at room temperature for 7 days, the SWARD film harness of the dried epoxy films were determined according to ASTM D2134 on a SWARD Hardness Rocker. The results are shown in Table 5 as follows, where the reported figures are the average number of oscillations from three readings:

TABLE 5
SWARD Hardness Tests

| Added Diluent | 5% | 10% | 15%′ | 20% | 25% |
|---|---|---|---|---|---|
| Blank Panel | 21.66 | 21.66 | 21.66 | 21.66 | 21.66 |
| None (Control) | 11.33 | 11.33 | 11.33 | 11.33 | 11.33 |
| Xylene/EPON ™ | | | | | |
| 828 | | | | | |
| CA 118 | 8.33 | 3 | 1.67 | 1 | 2.33 |
| Epodil ® 741 | 9.33 | 3.33 | 3.33 | 1.33 | 1.67 |
| Epodil ® 746 | 7 | 2.33 | 1.33 | 0.67 | 2 |
| Heloxy ™ Mod. 8 | 8.33 | 3 | 1 | 1 | 1 |
| Cardura ™ E10P | 8 | 2.66 | 1 | 1 | 1.67 |
| Heloxy ™ Mod. 505 | 9.66 | 3.66 | 2 | 2 | 2 |

### EXAMPLE 6

For Example 6, ADM CA 118 was used in place of the known Cardura™ E-10P reactive diluent in a waterborne epoxy according to Hexion Published Formulation 1705, Two Component Gloss White Enamel, to evaluate its ability to improve the flexibility of the resulting cured film as well as assess the comparative performance of ADM CA 118 as an alternative, biobased diluent and modifier in respect of a variety of other attributes, including viscosity and viscosity reduction, potlife, gloss, hardness, impact resistance, MEK resistance and drying time. The comparable EEWs of ADM CA 118 and Cardura™ E-10P reactive diluent allowed a substantially equivalent epoxy:amine stoichiometric ratio to be maintained between the respective waterborne epoxies prepared using the two diluents, at a substitution of the Cardura™ E-10P reactive diluent by an equivalent mass of the inventive ADM CA 118 diluent. Further, for the film prepared using ADM CA 118 as a diluent, as ADM CA 118 is sold as a coalesecent for latexes currently, a substitution was also done for the Texanol® 2,2,4-trimethyl-1,3-pentanediol monoisobutyrate coalescent conventionally specified for use in the curing agent package by an equivalent mass of the ADM CA 118 diluent. The details of the formulation with the ADM CA 118 in replacement of both the Cardura™ E-10P reactive diluent and the Texanol® coalescent are shown below. The formulation using the Cardura™ E-10P reactive diluent and the Texanol® 2,2,4-trimethyl-1,3-pentanediol monoisobutyrate coalescent was identical but for the substitution of ADM CA 118 for both of these materials.

Hexion Formula 1705 with ADM CA 118 Substitution

| Ingredients | Pounds | Gallons | Supplier |
|---|---|---|---|
| Part A | | | |
| ADM CA118 ™ | 10.8 | 1.35 | ADM Evolution Chem |
| TAM-20 Surfactant | 4.50 | 0.82 | Ethox Chem |
| OI Water | 124.3 | 14.89 | |
| Optiflo H-600 | 0.40 | 0.05 | Byk-Chemie |
| TI-Pure ® R-960 | 198.2 | 6.14 | Dupont |
| Byk ® 022 | 0.4 | 0.05 | Byk Chemie |
| Epi-rez ™ Resin G520-WH53 | 387.3 | 43.03 | Hexion |
| Drewplus ® L-479 Defoamer | 1.0 | 0.13 | Ashland |
| DoWanol ® PPh | 26.0 | 2.95 | Dow Chemicals |
| DoWanol ® DPnB | 20.6 | 2.72 | Dow Chemicals |
| DI Water | 65.8 | 7.88 | |
| Total | 839.3 | 80.00 | |
| Part B | | | |
| Epikure ™ Curing Agent 5870-W-53 | 172.4 | 18.95 | Hexion |
| Epikure ™ Curing Agent 3253 | 5.0 | 0.61 | Hexion |
| Raybo ® 60 | 0.8 | 0.9 | Raybo |
| ADM CA118 ™ | 2.8 | 0.36 | ADM Evolution Chem |
| Total | 181.0 | 20.00 | |
| Total Part A and B | 1020.3 | 100.0 | |

TAM-20: ethoxylated amine surfactant
Optiflo H-600: VOC free aqueous solution of a proprietary nonionic hydrophobe modified polymer

Ti-Pure R-960: chloride process rutile titanium dioxide pigment
Byk 022: VOC free silicone-containing defoamer
Epi-Rez 6520-WH-53: 53% solids, nonionic aqueous dispersion of a modified EPON Resin 1001 type solid bisphenol A epoxy (500-600 EEW)
Drewplus L-475: nonionic antifoam blend of mineral oils and silica Derivatives
Dowanol Pph: propylene glycol phenyl ether
Dowanol DPnB: dipropylene glycol n-butyl ether
Epikure 6870-W-53: 53% solids, non-ionic aqueous dispersion of a modified polyamine adduct curing agent
Epikure 3253: tris(dimethyl amino-methyl)phenol
Raybo 60: mixture of alkylamine and sodium nitrite

Formulation Constant

| | |
|---|---|
| Density, lbs/gal Part A | 10.50 |
| Part B | 9.05 |
| Part A and B mix | 10.20 |
| % Volume Solids, Part A and B mix | 40.80 |
| % Weight Solids, Part A and B mix | 50.20 |
| % PVC, Part A and B | 15.00 |
| VOC g/L, Part A and B (Texanol ™) | 165.0 |
| (ADM CA118 ™) | 162.0 |
| Mixing Ratio - Part A:Part B - by weight | 4.6:1.0 |
| -by volume | 4:1 |
| Epikure ™ per 100 parts Epoxy/Cardura ® E-10P | 22.32 |
| Epikure ™ per 100 parts Epoxy/ADM CA118 ™ | 22.49 |

Films were prepared from both formulations, and evaluated according to the indicated tests and with the results shown in Table 6 below:

TABLE 6
General Coating Properties

| Properties | Cardura ™ E-10P | ADM CA118 ™ |
|---|---|---|
| Viscosity, Krebs, Stormer, | 71.0 | 72.0 |
| ku - Initial - Part A | | |
| Part B | 84.5 | 88.7 |
| Equilibrated - Part A | 88.4 | 94.8 |
| Part B | 89.6 | 92.6 |
| Gloss, BYK Micro Tri-Gloss | | |
| Meter, 60 Deg | | |
| Leneta WB Paper 6 mils | 95.0 | 96.1 |
| QPanel CRS 5 mils | 93.6 | 93.6 |
| Opacity, X-Rite Color i5 | 95.0 | 94.5 |
| Spectrophotometer, 3 mils | | |
| Sward Hardness, ASTM D2134 | 6.5 | 5.5 |
| # of Oscillations 1 day cure | 8.5 | 7.5 |
| 3 days cure | 9.5 | 8.5 |
| 7 days cure | 9.5 | 9.5 |
| 14 days cure | | |
| Pencil hardness, ASTM | 2B | 2B |
| D3363 1 day cure | | |
| 3 days cure | B | B |
| 7 days cure | B | B |
| 14 days cure | B | B |
| Cross Cut Adhesion, | 5B | 5B |
| ASTM D3359 7 days cure | | |
| 14 days cure | 5B | 5B |
| Impact, ASTM D6905, | 100 | 120 |
| inch-lb 7 days cure direct | | |
| reverse | 60 | 120 |
| 14 days cure direct | 40 | 80 |
| reverse | 10 | 30 |
| Potlife, - 85% drop | 3.5-4.0 hours | 3.5-4.0 hours |
| in gloss | | |
| Drying Time⁷, ASTM | 17.5 mins | 17.5 mins |
| D5895 Set-to-touch | | |
| Tack free | 43.5 mins | 47.5 mins |
| Dry-hard | 3.0 hours | 3.25 hours |
| Dry-through | 4.15 hours | 4.30 hours |
| MEK Double Rubs⁸, | 80 | 78 |
| ASTM D4782 1 day cure | | |
| 3 days cure | 104 | 106 |
| 7 days cure | 132 | 140 |
| Corrosion Resistance - | | |
| 5% Salt Immersion | | |
| 3 day Immersion | | |
| Dry Film Thickness, mils | 2.70-2.90 | 2.60-2.80 |
| Blister Formation⁹ | #4, Medium | #4, Medium |
| Surface Rust Formation¹⁰ | Pinpoint Rust, | Pinpoint Rust, |
| | 8-P 0.1% | 9-P 0.03% |
| Underneath Rust Formation¹⁰ | General Rust, | General Rust, |
| | 5-G 3% | 4-G 10% |
| 7 day Immersion | | |
| Dry Film Thickness, mils | 2.50-2.80 | 2.50-2.70 |
| Blister Formation⁹ | #2, Medium Dense | #2, Medium Dense |
| Surface Rust Formation¹⁰ | Pinpoint Rust, | Pinpoint Rust, |
| | 7-P 1.0% | 8-P 0.1% |
| Underneath Rust Formation¹⁰ | General Rust, | General Rust, |
| | 4-G 10% | 4-G 10% |

On the MEK Double Rub resistance test, a ball peen hammer weighing 347.5 grams and wrapped with cheesecloth was used instead of an index finger as described in ASTM D4782. Blister formation was assessed per ASTM D714, while rust formation was evaluated according to ASTM D610.

### EXAMPLE 7

In Example 7, the inventive ADM CA 118 biobased diluent was evaluated in comparison to the known Cardura® E-10P reactive diluent, in an epoxy resin formulation intended for use as a wood floor coating or concrete sealer.

Procedure: Hexion Published Formulation 1703, Waterborne Wood Floor Coating and Epoxy Concrete Sealer, was used as the formulation reference, using first Cardura® E-10P as the diluent for the Epoxy Resin 6520-WH-53 (Part A). Epikure Curing Agent 6870-W-53 (Part B) was used as the curing agent.

Then, a second epoxy resin composition was prepared according to the same formulation reference, but replacing the Cardura® E-10P diluent with an equivalent mass of the ADM CA118 diluent.

The formulation details for the epoxy resin composition using the conventional diluent are shown below, while the formulation details for the composition using the inventive ADM CA 118 diluent were the same except for the substitution of the novel biobased diluent for the known diluent.

Formulation Table: Reference Hexion Formulation 1703

| Ingredients | Pounds | Gallons | Supplier |
|---|---|---|---|
| Part A | | | |
| Epi-rez ™ Resin 6520 WH-53 | 541.3 | 60.14 | Hexion |
| Dowanol ® DPnB | 37.8 | 4.98 | Dow Chemicals |
| Dowanol ® PPh | 37.8 | 4.29 | Dow Chemicals |
| ADM CA118 ™ | 14.0 | 1.75 | ADM Evolution Chem |
| Byk 807 | 5.8 | 0.68 | Byk Chemie |
| Water | 14.9 | 1.79 | |
| Total | 651.6 | 73.63 | |
| Part B | | | |
| Epikure ™ Curing Agent 6370-W-53 | 240.0 | 26.37 | Hexion |
| Total | 240.0 | 26.37 | |
| Total Part A and B | 891.60 | 100.0 | |

Formulation Constant

| | |
|---|---|
| Density, lbs/gal Part A | 8.84 |
| Part B | 9.10 |
| Part A and B mix | 8.92 |
| % Volume Solids, mix | 44.4 |
| % Weight Solids, mix | 49.4 |
| % PVC | 0.0 |
| VOC g/L | 204 |
| Mixing Ratio - Part A:Part B - by weight | 2.72:1 |
| - by volume | 2.79:1 |
| Epikure ™ per 100 parts Epoxy/Cardura ® E-10P | 40.00 |
| Epikure ™ per 100 parts Epoxy/ADM CA118 ™ | 40.28 |

Byk 307: polyether modified polydimethylsiloxane

General coating properties were assessed for cured coatings from these two formulations, and chemical resistance evaluations relevant to the particular application were also conducted on twice-coated oak and cement substrates to which the conventional and inventive diluent formulations had been applied. These results are reported in Tables 7-9, below:

TABLE 7
General Coating Properties

| Properties | Cardura ™ E-10P | ADM CA118 ™ |
|---|---|---|
| Viscosity, Krebs Stormer, | 133.7-91.3 | 132.4-91.3 |
| ku - Part A - Part B | | |
| Part A without Diluent | 136.1 | 136.1 |
| Gloss, BYK Micro Tri- | | |
| Gloss Meter, 20 deg | | |
| Leneta WB Paper 6 mils | 97.1 | 100 |
| QPanel CBS 6 mils | 108 | 110 |
| Sward Hardness⁵, ASTM | 3 | 3 |
| D2134, 1-day cure | | |
| 7-day cure | 7 | 7 |
| Pencil Hardness⁵, ASTM | 2B | 2B |
| D3363 1-day cure | | |
| 7-day cure | 2B | 2B |
| Cross Cut adhesion, | 5B | 5B |
| ASTM D3359 | | |
| Impact, ASTM D6905 | 160/160 | 160/160 |
| (direct/reverse), inch-lb | | |
| Potlife, Gel time | 5 hours | 5 hours |
| Drying Time, hours - | 3 | 3 |
| ASTM D5895 Set-to-touch | | |
| Tack free | 7 | 6.5 |
| Dry-hard | 13.5 | 12.5 |
| Dry-through | 15.5 | 15.0 |

TABLE 8
Chemical Resistance on an Oak Substrate (2 coats)

| Properties | Cardura ™ E-10P | ADM CA118 ™ |
|---|---|---|
| Chemical Resistance | | |
| (24 hours soak) | | |
| Water | NC | NC |
| 409 Cleaner | NC | NC |
| Vinegar | NC | NC |
| 70% IPA | NC | NC |
| 50% Bleach | NC | NC |
| 190 Proof Ethanol | Slight decrease | Slight decrease |
| | in gloss/film | in gloss/film |
| | softening with | softening with |
| | hardness recovery | hardness recovery |
| 50% Ethanol | NC | NC |
| 1.4% Ammonia Water | NC | NC |
| Mustard | NC | NC |

TABLE 9
Chemical Resistance on a Cement Board Substrate (2 coats)

| Properties | Cardura ™ E-10P | ADM CA118 ™ |
|---|---|---|
| Chemical Resistance - | | |
| 24 hours soak | | |
| Water | NC | NC |
| 20% Detergent | NC | NC |
| Motor Oil | NC | NC |
| Brake Fluid | Film softening | Film softening |
| 5% NaCl | NC | NC |
| 10% H₂SO₄ | Film Whitening | Film Whitening |
| | but recovered | but recovered |
| Hydraulic Fluid | NC | NC |
| Transmission Oil | NC | NC |
| Chemical Resistance - | | |
| Cement Board | | |
| Skydrol ® (MIL PRF | | |
| 8752578 | | |
| 3-day cure | | |
| 1 hour soak | NC | NC |
| 3 hours soak | NC | NC |
| 6 hours soak | NC | NC |
| 24 hours soak | NC | NC |
| 7-day cure | | |
| 1 hour soak | NC | NC |
| 3 hours soak | NC | NC |
| 6 hours soak | NC | NC |
| 24 hours soak | NC | NC |

1. An epoxy resin composition, comprising an epoxy resin and a reactive diluent comprised of one or more of the monoesters of epoxidized soy oil characterized by a ratio of mols of epoxide groups to mols of ester on the whole of at least 1.35:1.

2. The epoxy resin composition of claim 1, wherein the one or more monoesters of epoxidized soy oil are characterized by a ratio of mols of epoxide groups to mols of ester on the whole of at least 1.37:1.

3. The epoxy resin composition of claim 2, wherein the one or more monoesters of epoxidized soy oil are characterized by a ratio of mols of epoxide groups to mols of ester on the whole of at least 1.39:1.

4. The epoxy resin composition of any of claims 1-3, including at least one monoester of epoxidized soy oil having an oxirane content of less than 6.2%.

5. The epoxy resin composition of any of claims 1-3, wherein the reactive diluent comprises one or more monoesters of epoxidized soy oil selected from the group consisting of the methyl, ethyl, propyl, butyl, amyl, 2-ethylhexyl, benzyl, 5-(hydroxymethyl)furfuryl, 2,5-bis(hydroxymethyl)tetrahydrofurfuryl monoesters of epoxidized soy oil and mixtures thereof.

6. The epoxy resin composition of any of claims 1-3, wherein the reactive diluent is a mixture of epoxidized soyate esters from the interesterification of epoxidized soy oil with ethyl acetate.

7. The epoxy resin composition of claim 5, wherein the reactive diluent comprises the methyl esters of epoxidized soy oil as made by the epoxidation of soy biodiesel.

8. The epoxy resin composition of claim 5, wherein the reactive diluent comprises the methyl esters of epoxidized soy oil as made by the esterification of epoxidized soy oil with methanol.

9. The epoxy resin composition of claim 5, wherein the reactive diluent comprises the benzyl esters of epoxidized soy oil from the transesterification of soy biodiesel with benzyl alcohol to form the benzyl esters of soy oil, and then epoxidizing the benzyl esters of soy oil.

10. (canceled)
